(19) United States
(12) Patent Application Publication
(10) Pub. No.: US 2008/0102772 A1
(43) Pub. Date: May 1, 2008

(54) Carrier growth planning based on measured airlink transmission latency in 1x-EVDO wireless network

(76) Inventor: Asif D. Gandhi, Iselin, NJ (US)

Correspondence Address: MCCORMICK, PAULDING & HUBER LLP, 185 ASYLUM STREET, CITY PLACE II, HARTFORD, CT, 06103, US

(21) Appl. No.: 11/586,926

(22) Filed: Oct. 26, 2006

(51) Int. Cl. H04B 1/18

(52) U.S. Cl. 455/187.1

(57) ABSTRACT

For carrier growth planning in a wireless network, one or more airlink data transfer performance indicators are measured for a plurality of wireless units at a number of different times. The performance indicators may include user perceived throughput (UPT) and transmission latency or delay, as relating to batch or burst data transfers. Typically, the performance indicators are measured as a function of airlink loading, such as percentage of busy slots. After one or more optional statistical procedures, such as averaging, the performance indicators are compared to one or more performance criterion. In the case of UPT, for example, the performance criteria may be a set or range of minimum desired UPT values, for different loading levels, as established by the service provider. If the performance indicators meet the criteria, this indicates against adding airlink bandwidth in an effort to improve performance. Otherwise, increased airlink bandwidth may be warranted.

### FIELD OF THE INVENTION

The present invention relates to communications and, more particularly, to wireless communication systems.

### BACKGROUND OF THE INVENTION

Wireless, radio frequency communication systems enable people to communicate with one another over long distances without having to access landline-connected devices such as conventional telephones. In a typical cellular telecommunications network (e.g., mobile phone network), an area of land covered by the network is geographically divided into a number of cells or sectors, which are typically contiguous and which together define the coverage area of the network. Each cell is served by a base station, which includes one or more fixed/stationary transceivers and antennae for wireless communications with a set of distributed wireless units (e.g., mobile phones) that provide service to the network's users. The base stations are in turn connected (either wirelessly or through land lines) to a mobile switching center (“MSC”) and/or radio network controller (“RNC”), which serve a particular number of base stations depending on network capacity and configuration. The MSC/RNC act as the interface between the wireless/radio end of the network and a public switched telephone network or other network(s) such as the Internet, including performing the signaling functions necessary to establish calls or other data transfer to and from the wireless units.

Various methods exist for conducting wireless communications between the base stations and wireless units. One such method is the CDMA (code division multiple access) spread-spectrum multiplexing scheme, widely implemented in the U.S. under the “IS-95,” “IS-2000,” or other standards. In a CDMA-based network, transmissions from wireless units to base stations are across a single frequency bandwidth known as the reverse link, e.g., 1.25 MHz centered at a first designated frequency. Generally, each wireless unit is allocated the entire bandwidth all of the time, with the signals from individual wireless units being differentiated from one another using an encoding scheme. Transmissions from base stations to wireless units are across a similar frequency bandwidth (e.g., 1.25 MHz centered at a second designated frequency) known as the forward link. The forward and reverse links may each comprise a number of traffic channels and signaling or control channels, the former primarily for carrying data, and the latter primarily for carrying the control, synchronization, and other signals required for implementing CDMA communications.

While early systems were primarily configured for voice communications, technological improvements have enabled the development of “3-G” (third generation) and similar wireless networks for both voice and high-speed packet data transfer. For example, CDMA-based, “1×-EVDO” (Evolution Data Optimized, or Evolution Data Only) wireless communication networks, now implemented in many parts of the U.S. and elsewhere, use the CDMA2000® 3-G mobile telecommunications protocol/specification for the high-speed wireless transmission of both voice and non-voice data. 1×-EVDO is an implementation of CDMA2000® that supports high data rates, specifically, forward link data rates up to 3.1 Mbit/s, and reverse link rates up to 1.8 Mbit/s in a radio channel dedicated to carrying high-speed packet data, e.g., a 1.25 MHz-bandwidth radio channel separate from the radio channel for carrying voice data.

In wireless networks generally, and especially as 3-G wireless packet data networks evolve to support not only high-speed data transmission but also a wide range of unicast and broadcast/multicast multimedia services, one of the major challenges faced by service providers is to maintain acceptable quality of service (“QoS”) levels for those communicating over the network. Generally speaking, as network load increases, there is an increased likelihood of dropped calls, poor quality calls (e.g., resulting from increased frame error rates), long transmission latencies, and the like, all of which may lead to high user dissatisfaction rates. Service providers may combat quality of service issues by adding additional airlink bandwidth/capacity. Doing so can be costly, however, and service providers do not want to needlessly add capacity, or add capacity before it becomes necessary.

### SUMMARY OF THE INVENTION

An embodiment of the present invention relates to a method for assessing airlink performance in a wireless network, e.g., for purposes of carrier growth planning. By “airlink,” it is meant any radio-frequency channel or link over which data is transferred, e.g., the forward and/or reverse radio links of the wireless network. Initially, one or more performance indicators of the airlink are compared to one or more performance criterion for data transfer over the airlink. By “performance indicator,” it is meant a metric or measure of one or more data transfer characteristics across the network airlink (including possible statistical and/or trend analysis of such characteristics), typically as relating to a batch or burst data transfer for a particular wireless unit or group of wireless units. For example, the performance indicators may be user perceived throughput (“UPT”), and/or transmission latency/delay. Based on the comparison, it is determined whether or not to increase the capacity of the airlink, e.g., to add a carrier/additional bandwidth. The performance criteria will typically be established by the network service provider, and represent a limit (or set of limits) or other value corresponding to a desired minimum quality of service level for the network airlink.

In another embodiment, airlink capacity (e.g., bandwidth) is increased if the performance indicator(s) fails to meet the performance criteria. Otherwise, the performance indicators may be measured at a later time for determining if circumstances have changed such that the performance indicators no longer meet the performance criteria.

In another embodiment, the airlink performance indicator(s) is measured for a number of different wireless units at a number of different times, e.g., at all times, or only at typically busy or congested times. The performance indicators may be measured with respect to airlink loading, and may be subjected to a statistical operation prior to comparison to the performance criteria, such as averaging or the like.

### BRIEF DESCRIPTION OF THE DRAWINGS

The present invention will be better understood from reading the following description of non-limiting embodiments, with reference to the attached drawings, wherein below:

FIG. 1 is a schematic diagram of a 1×-EVDO wireless network;

FIG. 2 is a flow chart showing a method of carrier growth planning according to an embodiment of the present invention;

FIGS. 3A-3F are graphs illustrating various performance indicators, plotted as a function of network loading, for purposes of carrier growth planning;

FIG. 4 is a flow chart showing a method of carrier growth planning according to an additional embodiment of the present invention;

FIG. 5 is a graph of performance indicators plotted at the sector level;

FIG. 6 is a schematic diagram of a method and system for determining airlink transmission latency and/or user perceived throughput (“UPT”) on a wireless network;

FIGS. 7 and 8 are flow charts illustrating various methods for determining airlink transmission latency and/or UPT;

FIGS. 9 and 10 illustrate another system and method for determining airlink transmission latency and/or UPT; and

FIGS. 11-13 are schematic diagrams showing additional systems/methods for determining transmission latency and/or UPT.

### DETAILED DESCRIPTION

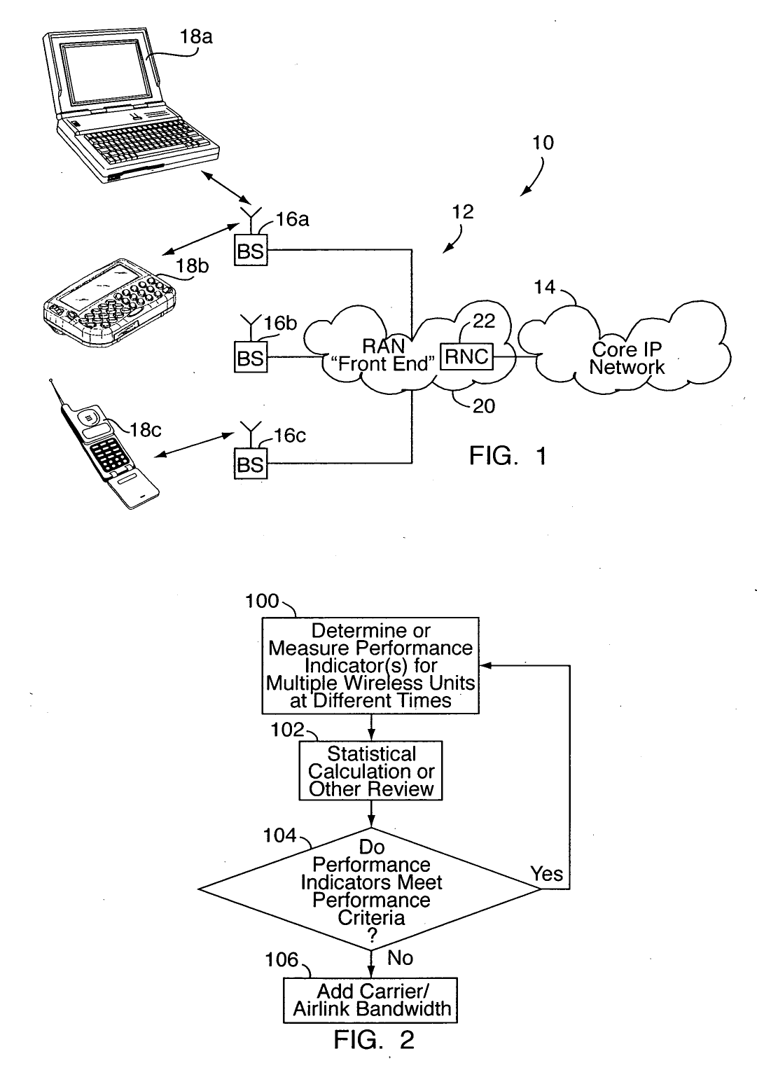

With reference to FIGS. 1-13, an embodiment of the present invention relates to a method for carrier growth planning in a wireless communication network 10, e.g., a CDMA-based 1×-EVDO network or other wireless network, based on measured airlink transmission latency or other performance indicators. (“Airlink” refers to any radio channel or link over which data is transferred, e.g., the forward and/or reverse radio links of the wireless network 10.) The wireless network 10 may include a radio access network portion (“RAN”) 12 and a core IP (Internet Protocol) network portion 14. The RAN 12 includes one or more fixed base stations 16a-16c (“BS”) each with various transceivers and antennae for radio communications with a number of distributed wireless units 18a-18c, e.g., mobile phones, “3-G” (third generation) wireless devices, wireless computer routers, and the like. The base stations 16a-16c are in turn connected to a RAN “front end” 20, which may include a mobile switching center and/or radio network controller (“RNC”) 22 and other components which together act as the interface between the base stations 16a-16c and core IP network 14, including directing data transfer to and from the base stations 16a-16c for transmission to the wireless units 18a-18c.

Generally speaking, carrier growth planning refers to assessing network/system performance to determine if a wireless network requires the implementation of additional resources to maintain certain minimum performance criteria. According to the present invention, one or more data transfer performance indicators of the network 10 are measured (typically as a function of airlink loading) and assessed in view of the performance criteria. By “performance indicator,” it is meant a metric or measure of one or more data transfer characteristics across a network airlink, as relating to a batch or burst data transfer for a particular wireless unit. If the performance indicators fail to meet the criteria (e.g., indicating that performance is not acceptable), an additional carrier (e.g., airlink bandwidth or other resources) may be added. This process of carrier growth planning based on assessed performance indicators is summarized in FIG. 2. There, at Step 100 one or more performance indicators are measured for multiple wireless units 18a-18c (e.g., some or all of the wireless units in communication with the wireless network 10) at different times in the wireless network, e.g., at all times, or only at typically busy times. (Suitable performance indicators and how they may be measured are discussed below.) At Step 102, the performance indicators, as determined at Step 100, are optionally subjected to one or more statistical procedures, calculations, and/or trend analysis procedures, depending on how the information is to be used. At Step 104, it is determined if the performance indicators meet one or more performance criterion for the network. If not (e.g., if performance is unsatisfactory), a carrier or other bandwidth may be added as at Step 106. If so (e.g., if performance is currently satisfactory), the process may be repeated at a later date, as back at Step 100, to determine if conditions have changed. It should be noted that this process is applicable for limitations imposed by the air interface, and assumes that hardware resources and backhaul are adequate and that network performance is limited by the radio/physical layer air interface. If this is not the case, or if it is desired to assess performance elsewhere in the network, the process may be adapted for other network links or channels. Additionally, the performance indicators may be for the forward link, the reverse link, or both.

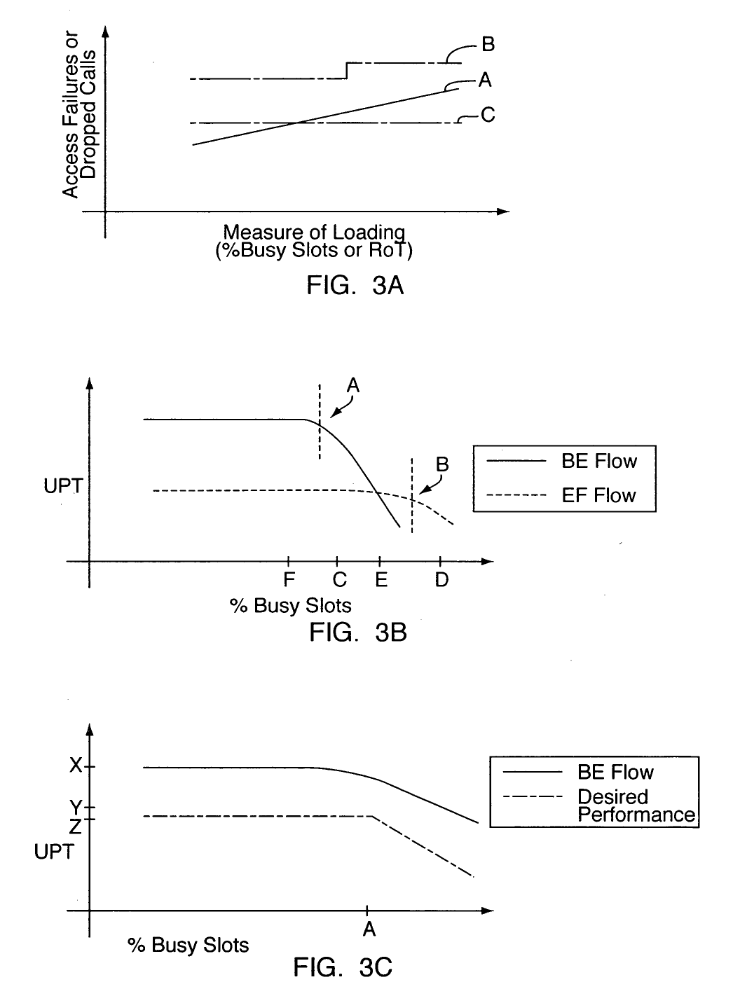

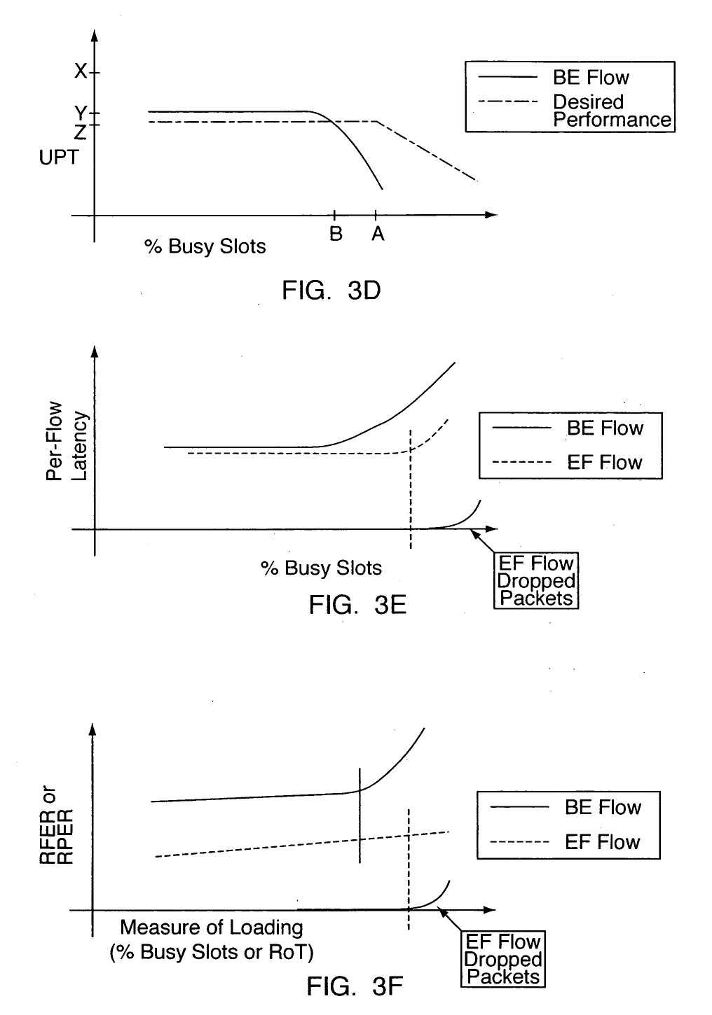

As noted, the performance indicators evaluated under the present invention are a metric or measure of one or more data transfer characteristics across a network airlink, as typically relating to a batch or burst data transfer for a particular wireless unit, as a function of system loading. Suitable performance indicators include (i) the number of access failures and dropped calls, (ii) transmission latency or delay, (iii) user perceived throughput (“UPT”), (iv) reverse frame error rate (“RFER”) or reverse packet error rate (“RPER”), and the like. Regarding the former, the need for adding airlink capacity can be gauged by observing, in an individual sector or cluster of sectors, the number of access failures (e.g., the inability to make a call) and/or the number of dropped calls/transmissions, e.g., when an established or ongoing transmission is terminated at the network level. Access failures and dropped calls typically trend upwards with airlink loading. Thus, as shown in FIG. 3A, these factors may be gauged with respect to a measure of airlink loading, such as reverse link RoT (rise over thermal) or the percentage of busy slots. In the EVDO forward link, one user in a sector is served at a time. The shortest time unit for switching between users is a “slot,” which is 1.667 ms in duration. (Put another way, there are 600 slots in a second.) In EVDO Rev 0, since only one user can be served in a slot, the slot is the basic resource of the forward link. In EVDO Rev A, multiple users can be served in a slot, but the slot still remains the basic unit of resource, since EVDO (Rev 0 or Rev A) remains a time division multiplexed (“TDM”) system. The percentage of busy slots used is a measurement that is available and is a primary indicator of airlink usage. In either case, when the factor of interest, e.g., access failures or dropped calls, reaches a certain limit, a service provider may decide to add another carrier to accommodate traffic growth and maintain system performance.

As should be appreciated, the exact limit of when another carrier is added will depend on the desired level of performance in the network. In FIG. 3A, for example, curve “A” represents a possible plot of dropped calls, access failures, or other performance indicators as a function of airlink loading. If the performance criteria are as shown by curve “B,” as established by the service provider, then the performance indicators meet the performance criteria. That is, in this example, the number of dropped calls or the like, at all levels of airlink loading, is bellow a maximum value or values set by the service provider. This tends to indicate away from adding a carrier/airlink bandwidth. If on the other hand the performance criteria are as shown by curve “C,” then the performance indicators of curve A do not meet the performance criteria across all areas of interest, meaning that the service provider should consider adding airlink bandwidth when the metric crosses the acceptable level.

Although the level of dropped calls and/or access failures is a useful barometer of airlink performance, it is oftentimes the case that high levels of dropped calls and access failures do not occur until airlink performance has degraded below levels that may be acceptable to network users. In other words, airlink performance may become unacceptable before high levels of dropped calls and access failures are reached. Accordingly, if the level of dropped calls and/or access failures is within acceptable limits, other performance indictors such as UPT and transmission latency may be evaluated.

To elaborate, UPT and transmission latency or delay may be the leading indicators of airlink/RF performance in certain wireless networks. Regarding transmission latency, in a wireless network where data is transferred in packets, for example, transmission latency is typically measured as the time it takes for one or more packets to travel from a radio access network input, such as a radio network controller pre-buffer, to a base station including transmission out over the air. In “best efforts” 1×-EVDO wireless networks, “blocking”-type measures are unavailable, and data packets cannot be blocked based on delay. Eventually, all data bits will make it through for transmission over the air. Accordingly, one measure of how well the network is functioning (and whether it is at capacity) is the latency in transferring data packets across the wireless network. Especially in 3-G and similar wireless networks involving high-speed batch data transfer, UPT is also a valuable performance indicator. UPT is a sense or measure of how fast data is being received at a wireless unit, as actually perceived by the user. For example, in downloading a large file from the Internet, or in browsing web pages, users are typically unconcerned with the average data throughput of the network, peak data rates, or similar generalized performance indicators. Instead, users are more typically interested in the amount of time for a batch data transfer, e.g., the time to download a particular file or other set grouping of related data. In such a case, UPT may be measured as the ratio of download size (in number of bits or the like) to time, as measured from when the file is requested to when the download is completed. More generally, UPT may be characterized as the data transfer rate in terms of bits per second, e.g., the ratio of data size to the time between when the data is requested and when the data is received, in units of kbits/second (“kbps”), Mbits/second (“Mbps”), or the like. UPT may also be calculated as the amount of data remaining for transfer to the wireless unit divided by the transmission latency. For example, if the “click to receive” time is 144 ms for 180 data packets, the UPT would be 1.28 Mbps (assuming 1024 bits/packet).

For using UPT to assess possible carrier growth in a wireless network, UPT values are calculated at a number of different times for a number of different wireless units. (This process is described further below.) These values are then evaluated in light of one or more performance criterion, as relating to UPT, for the network. Thus, if it is desired for a wireless network 10 to maintain UPT within a particular range even during busy periods, a downturn in average UPT at particular times of day below a desired limit may signify the need to add another airlink carrier (e.g., additional carrier bandwidth) to the RAN for increasing data transfer capacity. For example, if a service provider desires to maintain UPT within a range of 300-500 kbps, if the UPT falls to an average of 150-200 kbps during busy times, the service provider may decide to add another carrier. FIG. 3B shows a typical plot of UPT as a function of percentage of busy slots for best efforts (“BE”) and expedited forwarding (“EF”) flows in a 1×-EVDO network. In a BE flow, although all data packets are eventually delivered, the packets are treated in the same fashion; the network undertakes to deliver every data packet as quickly as it can without differentiation for quality of service purposes or otherwise. Expedited forwarding is a network service wherein certain data packet flows are given a high priority. This may be offered as a premium service, and/or used for delay critical or intolerant applications. The aim of EF is to provide low priority to certain data packets. Since EF bits/packets have priority over the BE flow bits/packets, it is expected that the UPT for BE flow is likely to degrade (point A) prior to the UPT for the EF flow (point B). UPT for both flows can be monitored on an ongoing basis, for possible carrier growth if the downturns occur at an unsatisfactory level of airlink loading. For example, if points F and E in FIG. 3B correspond to airlink loading levels above which downturns in UPT for BE and EF flows are acceptable, respectively (e.g., points F and E would typically be a relatively high percentage of busy slots), then the illustrated BE and EF curves, with downturns occurring at points A and B, would indicate against a need to add a carrier. On the other hand, if points C and D in FIG. 3B correspond to the levels below which downturns in UPT for BE and EF flows are unacceptable, respectively, then the illustrated BE and EF curves would indicate the need to add airlink bandwidth/capacity. Put another way, more generally, the curves in FIG. 3B would typically represent UPT vs. percentage of busy slots for individual sectors or a cluster of cells. The BE flow will trend down before the EF flow, with the service provider being able to monitor these trends for determining whether to add an EVDO carrier (or the like) when UPT starts to turn down and/or reaches an unacceptable level.

Again, the plots of BE and EF flows would be generated by measuring UPT as a function of percentage of busy slots for a plurality of wireless units, at various times of day, and possibly subjected to various statistical procedures such as averaging, standard deviation, or the like. UPT values corresponding to points F and E (or C and D) are performance criteria based on service provider considerations, such as user service level or plan, minimum user service guarantees, user surveys, advertising claims, and the like. There may be different performance criteria for different airlink flows, e.g., one set of criteria for BE flows and another for EF flows.

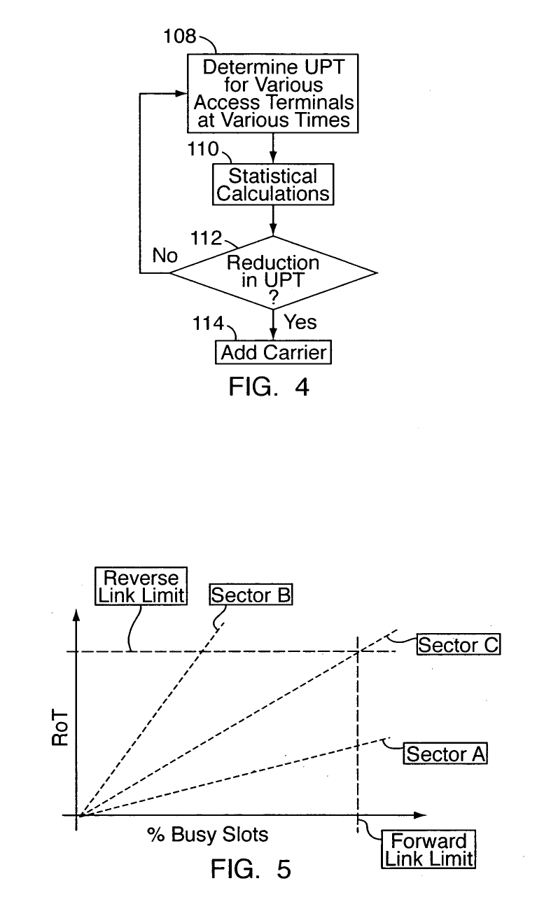

FIG. 4 summarizes the method for carrier growth planning based on UPT. At Step 108, the UPT is determined for various wireless units 18a-18c (e.g., some or all of the wireless units in communication with the wireless network 10), at various times (e.g., at all times, or only at typically busy times). At Step 110, the UPT information as determined at Step 108 is optionally subjected to one or more statistical procedures or calculations, depending on how the information is to be used. At Step 112, it is determined if the UPT value(s) from Steps 108 or 110 meet a designated performance criterion or criteria for the airlink. For example, it may be determined if UPT has fallen off (possibly in regards to calculations over previous times periods), is unacceptably low, or the like. If so, a carrier or other bandwidth may be added as at Step 114. If not, the process may be repeated at a later date, as back at Step 108.

As suggested in FIG. 3A, desired performance levels (or other criteria) for UPT or other performance indicators in a network, as based on service provider considerations, may themselves vary as a function of airlink loading, time of day, service level, and the like. For example, a service provider may offer a user guarantee of a certain UPT except at peak hours, at which times the UPT is not guaranteed, or is guaranteed at a lower level. Thus, UPT may be assessed, for carrier growth purposes, with respect to such varying criteria, as illustrated in FIGS. 3C and 3D. There, the service provider has established a minimum UPT level (labeled “desired performance”) that varies according to airlink loading, e.g., percentage of busy slots. In particular, the service provider desires to keep airlink UPT at least at a minimum level “Z” until a certain level of loading is reached (point “A”), at which time the UPT can drop as loading increases. (Point A may represent a loading level indicative of peak hours.) The desired performance curve acts, in effect, as a set of performance criteria for the airlink, as relating to UPT. In FIGS. 3C and 3D, for example, the criteria are that: (i) the UPT is at least “Z” up to point A; and (ii) the UPT declines no more than a designated linear rate after point A. In FIG. 3C, the UPT for network BE flow has been measured, and falls above the desired performance level for all loading levels. This means that the performance indicator has meet the criteria, and suggests that an additional carrier is not needed. In FIG. 3D, while measured UPT falls above the desired minimum for low loading levels (up to point “B”), it does not meet the desired level for high loading levels. This would suggest the need for adding an additional airlink carrier.

While FIGS. 3A-3D show “percentage of busy slots” as the measure of airlink loading, another possible measure is the percentage of busy slots used by EF flows. This is a measure of the fraction of slots that were used by the highest priority flow, such as EF flows. As the level of EF flow (or the like) increases, a lesser fraction of the slots will be available for non-EF flows (such as the BE flow), and metrics such as UPT and latency for the BE flows will degrade. Hence, another way to plot these performance metrics is versus the fraction of slots available for the EF flows or, in other words, the “fraction of slots busy with EF flows.”

Carrier growth assessments may also be based on measurements of transmission latency. FIG. 3E shows a typical plot of transmission latency for BE and EF flows as a function of percentage of busy slots. Again, it is expected that the latency for a BE flow will creep up before the latency for an EF flow. As loading is increased further, queuing and delay may cause the network to drop packets that have been delayed too much. This is shown as happening at a high level of airlink loading in FIG. 3E, as indicated by the “EF flow dropped packets” curve. For a well-run network (and to ensure that users do not perceive any service degradation), it is expected that sometime prior to significant degradation in the BE and/or EF flow latencies and/or UPT, a service provider would consider adding a carrier. In particular, degradations in BE flow latencies and/or UPT are leading indicators that carrier capacity has been reached.

FIG. 3F illustrates other group or type of performance indicators that may be used for evaluating carrier growth, namely, the reverse frame error rate (“RFER”) or the reverse packet error rate (“RPER”). Generally speaking, in some networks it is acceptable if these indicators creep upwards within some acceptable limit. As such, RFER and RPER are generally not a direct trigger for adding carriers. At a certain point when the system becomes loaded, however, it may be observed that the downgrades for constant bit rate flows start to increase, after which, again, the system may start to drop packets. Although it is expected that the latency and UPT impact on the BE flows will occur well before these downgrades (e.g., for constant bit rate “Assured Forwarding” flows) start an increasing trend, such trends may be monitored for and taken into account for assessing carrier growth.

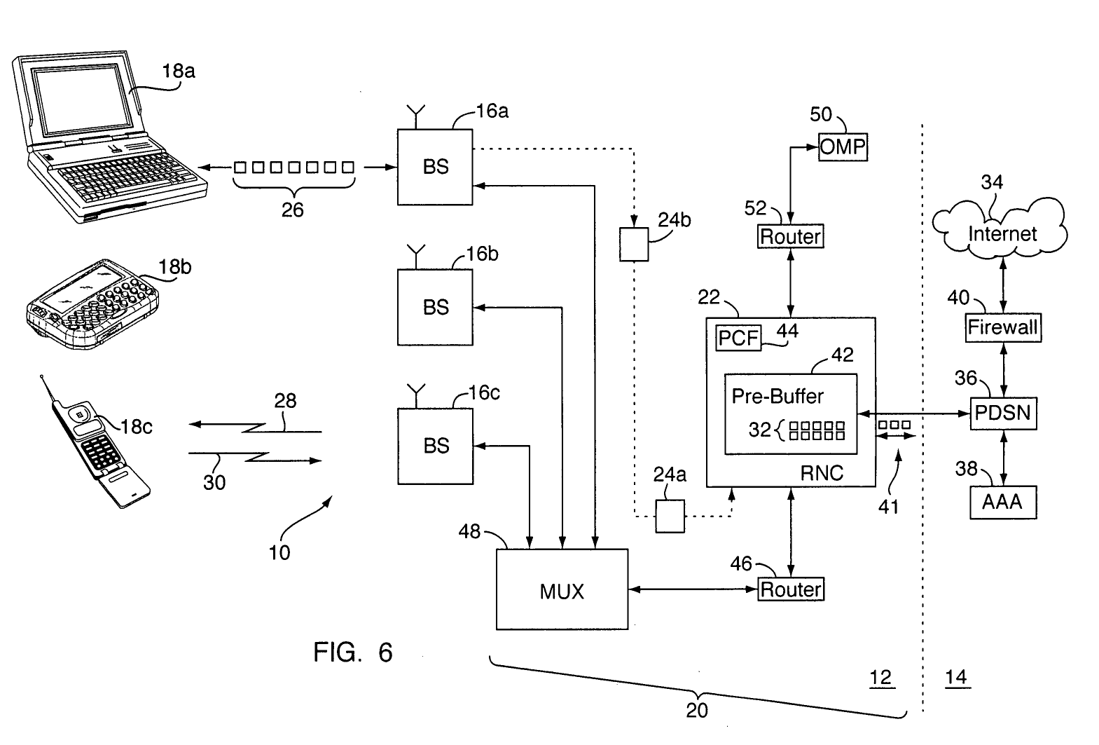

Another set of possible performance indicators, for use in conjunction with the above, is shown in FIG. 5, which provides a sector level view (as opposed to a user-level view in FIGS. 3A-3F). Here, a forward link resource constraint/limit is plotted on the x-axis. A reverse link resource constraint/limit is plotted on the y-axis. Plotting a sector's measurements in this way gives an idea of which is the limiting link. In FIG. 5, sector A is limited by the forward link, sector B is limited by the reverse link, and sector C is roughly balanced. If a sector reaches its limits in terms of the reverse link or forward link, this will be reflected as an impact (in terms of latency and UPT) on the BE flow in the respective direction, e.g., in measurements as shown in FIGS. 3B and 3E.

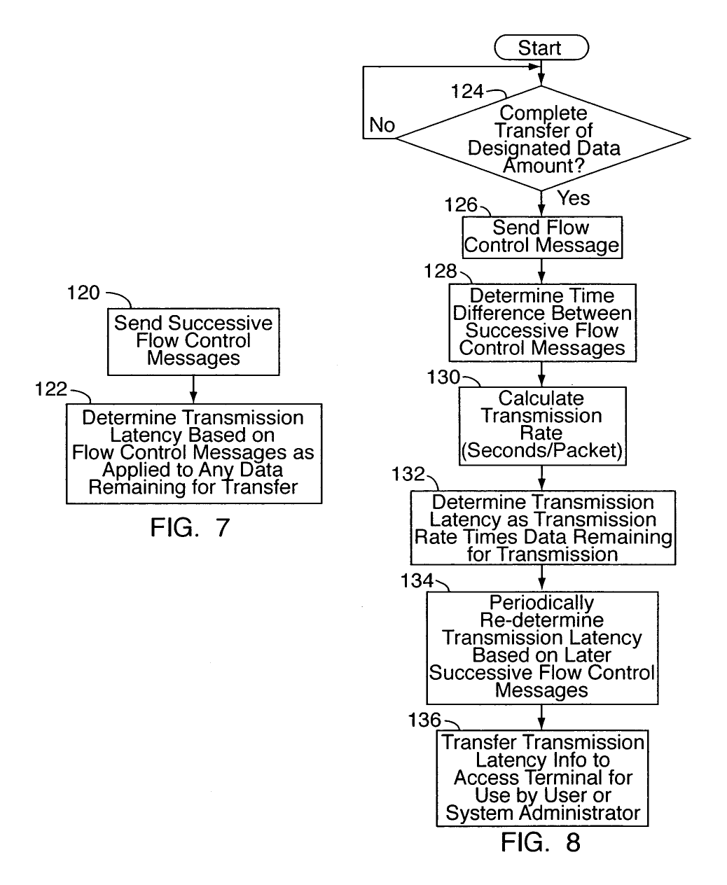

Regarding measuring the performance indicators such as UPT and transmission latency, one possible method for measuring airlink transmission latency, illustrated with respect to a base station 16a in communication with one of the wireless units 18a, is shown in FIGS. 6 and 7. At Step 120, the base station 16a, when communicating with the wireless unit 18a, sends successive flow control messages 24a, 24b to the RAN front end 20. Each message 24a, 24b is sent when the base station 16 completes the transfer of a designated amount of data 26 over the network airlink 28, 30 to the wireless unit 18. (By “transfer,” it is meant the reception and/or transmission of data.) The flow control messages 24a, 24b may each contain time data such as a time stamp of when the message was generated or sent, for use in determining the transmission latency. Subsequently, at Step 122 the transmission latency of the airlink is determined based on the successive flow control messages 24a, 24b as applied to any data 32 remaining for transfer to or from the wireless unit 18a, as further discussed below. In other words, the transmission latency is a calculation of the projected time for transferring the remaining data 32 over the airlink.

As noted, the network 10 may be a 1×-EVDO network including a RAN portion 12 and a core IP network portion 14. For conducting wireless communications between the base stations 16a-16c and the wireless units 18a-18c, the RAN 12 utilizes a CDMA spread-spectrum multiplexing scheme with a forward link 28 and a reverse link 30. As noted above, the network 10 may also utilize another radio channel (e.g., a third 1.25 MHz frequency bandwidth) dedicated to carrying high-speed packet data, with forward link data rates up to 3.1 Mbit/s and reverse link rates up to 1.8 Mbit/s. The RAN 12 may be geographically divided into contiguous cells, each serviced by a base station, and/or into sectors, which are portions of a cell typically serviced by different antennae/receivers supported on a single base station.

The network 10 may be connected to external networks such as a public switched telephone network, or to the Internet 34. For high-speed data transmission to and from the Internet or elsewhere (e.g., for facilitating web browsing, real time file transfer, or downloading large data files), the network 10 may use the Internet Protocol, where data is broken into a plurality of addressed data packets. Additionally, voice over IP (“VoIP”) may be used for voice-data transmission. (With VoIP, analog audio signals are captured, digitized, and broken into packets like non-voice data.) Both voice and non-voice data packets are transmitted and routed over the wireless network, where they are received and reassembled by the wireless units to which the data packets are addressed. For use in transferring packet data between the RAN 12 and external networks such as the Internet 34 (or otherwise), the core IP network portion 14 of the wireless network 10 may include a packet data serving node (“PDSN”) 36 for routing wireless unit originated or terminated packet data, an authentication, authorization, and accounting module (“AAA”) 38, and a firewall 40.

In the wireless network 10, as shown in FIG. 6, packet data 41 (e.g., arriving from the Internet 34 for transfer to a wireless unit 18a) is typically routed from the PDSN 36 to the RNC 22. The RNC 22 may include an input pre-buffer 42 for temporarily storing packet or other data, and a packet control function 44 for managing the relay of data packets between the PDSN 36 and base stations 16a-16c. The packet data is subsequently forwarded to a concentrator router 46, and then over a high capacity line to a high capacity multiplexer 48 for transfer to the base stations 16a-16c. The wireless network 10 may also include an operations management platform (“OMP”) 50 connected to the RNC 22 through a router 52, for providing enhanced operations, administration, maintenance, and provisioning functionality.

The process for determining airlink transmission latency will now be explained in further detail with reference to FIGS. 6 and 8. As noted above, upon their arrival at the RNC 22 from the PDSN 36, data packets 41 are stored in the RNC pre-buffer 42. For controlling the flow of packets between the RNC 22 and base stations 16a-16c, as part of a RAN data flow control scheme that functions on a per-wireless unit basis, the base stations 16a-16c periodically send flow control messages 24a, 24b to the RAN front end 20, e.g., to the RNC 22, to request additional data. In particular, at Steps 124 and 126, each time one of the base stations 16a completes the transfer of a designated amount of data 26 to a wireless unit 18a-18c, the base station 16a sends a flow control message 24a, 24b to the RNC 22. (It is also possible for the messages to be sent elsewhere in the RAN front end.) Upon receipt of the flow control message 24a, 24b, the RNC 22 knows to send additional data to the base station 16a. The designated amount of data 26 may be a static, pre-determined value based on network parameters and/or upon a desired level of granularity in terms of both data flow and determinations of transmission latency. For example, the designated data amount 26 could be fifty data packets, in which case each base station 16a-16c would send a flow control message 24a, 24b upon completing the transfer of fifty data packets to a wireless unit, with the RNC 22 subsequently commencing the transfer of fifty additional data packets to the base station upon receipt of each flow control message.

As noted above, the flow control messages 24a, 24b may each contain a time stamp or other time data of when they were generated and/or sent. Alternatively, time calculations may be based upon time data of when the flow control messages are received by the RNC 22 or otherwise. In either case, the difference “Δt” in time data (“t_{message1}” and “t_{message2}”) between two successive flow control messages 24a, 24b received from a particular base station 16a in regards to a particular wireless unit 18a is determined at Step 128 in FIG. 8:

Δt=t_{message2}−t_{message1}

As should be apparent, Δt corresponds to the amount of time it took the base station 16a to get the designated amount of data 26 (e.g., 50 packets) out over the airlink. At Step 132, the transmission rate (“TR”) of the designated data amount 26 may be calculated as the ratio of the time Δt between successive flow control messages 24a, 24b to the designated data amount 26:

TR=Δt/(designated data amount)

To determine the transmission latency “TL,” the transmission rate TR between successive flow control messages 24a, 24b is multiplied by the data remaining for transfer 32, as at Step 132:

TL=TR·(data remaining for transfer)

TL=(Δt/(designated data amount))·(data remaining for transfer)

Conceptually, the transmission latency is the amount of time it will take for the remaining data 32 to be sent out over the airlink. Alternatively, the TL can be thought of as the time in the RAN for a new packet arriving at the pre-buffer to be sent over the airlink presuming that conditions remain “quasi-stationary.”

As an example, say that the designated data amount 26 is fifty data packets, that the time stamp on a first flow control message 24a (in regards to a particular wireless unit) indicates a time of 13:44:32.000, and that the time stamp on a second, successive flow control message 24b indicates a time of 13:44:32.040. Say also that 180 data packet exist throughout the RAN 12 for transfer to the particular wireless unit, e.g., there are 180 data packets stored in the pre-buffer 42 or elsewhere. Based on the above, the time difference Δt between the two flow control messages is 40 milliseconds:

Δt=t_{message2}−t_{message1}=13:44:32.040−13:44:32:000=40 ms

Then, the transfer rate TR is calculated as:

TR=Δt/(designated data amount)=40 ms/50 data packets=0.8 ms per data packet

Finally, the transmission rate is applied to the data remaining to transfer to determine the transmission latency, e.g., an estimate of how long it will take for the remaining data to go out over the air:

TL=TR·(data remaining for transfer)=(0.8 ms/data packet)·(180 data packets)=144 ms.

Thus, if conditions in the wireless network 10 do not change, the last packet of the remaining 180 data packets would take 144 ms to be sent out over the airlink. Alternatively, a new packet arriving at that instance would take 144 ms before it is at the head of the queue to be sent out over the airlink.

Transmission latency will typically be determined for wireless units on an individual basis. Transmission latency may be determined for all the wireless units 18a-18c in communication with the wireless network, or only for some portion thereof, possibly based on certain types of activity. For example, determinations of transmission latency may be more relevant for situations involving large data transfers or the like. As indicated at Step 134, latency may be reevaluated periodically to capture changing RF and network conditions. Additionally, statistics can be evaluated as desired, including per-user averages, deviations, and averages over all users, using standard methods, for purposes of assessing carrier growth as described above.

UPT can be calculated in a similar manner as set forth above for determining transmission latency. In particular, as between successive flow control messages, UPT is determined as the ratio of bits transferred to Δt:

UPT=(designated data amount)·(bits/packet)/Δt[units: bits/sec]

(This assumes that the designated data amount is in units of packets; the designated data amount could be expressed in terms of bits, in which case there would be no need for a bits per packet conversion.) Thus, if there is a time difference Δt of 40 ms between successive flow control messages for a designated amount of data of 50 data packets, with each packet having 1024 bits:

UPT=(50 packets)·(1024 bits/packet)/40 ms=1.28 Mbits/sec (over this observation interval)

### Similarly, UPT can also be calculated as the data remaining for transfer 32 divided by the transmission latency TL (again, as estimated based on a particular observation interval):

UPT=(data remaining for transfer)·(bits/packet)/TL

From the above example:

UPT=(180 packets)·(1024 bits/packet)/144 ms=1.28 Mbits/sec.

One difference to be noted is that while it is acceptable to aggregate data over all the different wireless devices (18a-18b) served by a specific BS (e.g., 16a) for the purpose of calculating the latency, for UPT the calculation has to be for a specific wireless device (e.g., for 18a only, or 18b only) as the concept of UPT is related to the throughput that is perceived or noticed an individual user.

As should be appreciated, a delay anywhere in the wireless network 10 (e.g., due to a busy transmission line or otherwise) will directly impact transmission latency and user perceived throughput. This is because an additional delay in the designated amount of data arriving at a base station will show up as an increase in the time difference At between two successive flow control messages 24a, 24b. For example (with reference to the example above where two successive flow control messages 24a, 24b are spaced 40 ms apart for a designated data amount of 50 packets), suppose that one of the transmission lines between the RNC 22 and a base station 16a becomes congested, resulting in an additional delay of 60 ms. If the next time that a flow control message is sent to the RNC 22 is 100 ms later (40 ms original delay+60 ms additional delay), the 50 packets (the designated data amount) took a total of 100 ms to transfer. If 180 data packets remain for transfer, the transmission latency would be estimated as:

TL=(Δt/(designated data amount))·(data remaining for transfer)=(100 ms/50 packets)·(180 packets)=360 ms

UPT=(designated data amount)·(bits/packet)/Δt=(50 packets)·(1024 bits/packet)/100 ms≈500 kbps

UPT=(data remaining for transfer)·(bits/packet)/TL=(180 packets)·(1024 bits/packet)/360 ms≈500 kbps

Although these examples are based on a value of 1024 bits per packet (a typical maximum value), the actual number of bits per packet may be smaller or larger than this amount. Information about the actual number of bits per packet, for purposes of calculating UPT, transmission latency, or the like, may be incorporated into the flow control messages 24a, 24b or otherwise provided in software or hardware, e.g., as a data portion of a script or computer program for carrying out the method of the present invention.

The impact of connection drops or gaps in the airlink connection would similarly be reflected in transmission latency and UPT. Also, an increased number of users would have a similar impact. In particular, with more users time-sharing the radio channel, each would have a smaller fraction of allocated slots. Thus, more time would be required for transmitting the same amount of data, which would be reflected in transmission latency and UPT. For example, suppose a first wireless unit 18a is located in a network cell or sector such that it gets a channel or slot data rate (i.e., the airlink may be logically divided into slots for transferring packet data) of 1.3 Mbps. If the user of the wireless unit downloads a file (e.g., a webpage from the Internet), and if there are two other wireless units 18b, 18c in that sector also active over the airlink, the RNC 22 (or the BS 16) will assign about ⅓ of the slots to each wireless unit 18a-18c. Thus, for the short period of several hundreds of milliseconds while the page is being downloaded, the first wireless unit 18a will perceive an effective rate of UPT=1.3 Mbps/3=433 kbps. From the perspective of the activity over the airlink as a whole, the data throughput is 1.3 Mbps. However, what is of interest to the first user is the transmission latency or UPT, as relating to his or her particular wireless unit, during times when actually transferring data, here about 433 kbps.

Determinations of data transfer performance indicators such as UPT, transmission latency, and jitter may be made at different locations in the RAN 12, depending on the configuration of the wireless network and on how the UPT and transmission latency values are to be used. For example, instead of the UPT being measured at the RNC 22, the base stations 16a-16c could be configured to make note of the time data in successive flow control messages, and to calculate the UPT based on the time data and advanced knowledge of the designated data size 26 (assuming information regarding the amount of data 32 remaining for transfer was available to the base stations).

The methods described herein for determining transmission latency, UPT, and the like may be implemented using standard hardware and/or software techniques on a wireless network's existing equipment/infrastructure. For example, the RNC 22 could be outfitted with one or more scripts (i.e., computer programs) for calculating the time difference between successive flow control messages 24a, 24b, for calculating the data transfer rate, for determining transmission latency, etc. Of course, such scripts would also be configured for transmitting the information to a designated site or component for further use. For example, as at Step 136 in FIG. 8, the transmission latency or UPT could be sent for display on a wireless unit, or for display on a service provider terminal (not shown) connected to the wireless network 10, for use by technicians or network administrators.

Although the method of the present invention has been primarily described in regards to forward link transmissions, it is also applicable to reverse link transmissions. For example, in transferring a file across the wireless network 10, information regarding any data remaining for transfer (e.g., file size) could be supplied by the wireless unit transferring the data, and flow control messages could be sent either (i) from the RNC 22 to the base station for requesting additional data from the base station, or (ii) from the base station to the RNC 22, at the start or completion of transferring the designated amount of data 26, as a notice that data is being transferred (i.e., instead of as a request for additional data).

As indicated, the data transfer rate, transmission latency, UPT, etc. are typically determined in part based on the time difference between successive flow control messages 24a, 24b. As should be appreciated, by “successive” it is meant any two flow control messages relating to a single data transfer event for a wireless unit, and not necessarily two flow control messages that come one right after the other. For example, it is possible that as between three temporally contiguous flow control messages, a time difference between the first and third could be calculated, provided it is known that there was an intervening message for determining that there were two “groups” of the designated data amount 26 transferred during that time period.

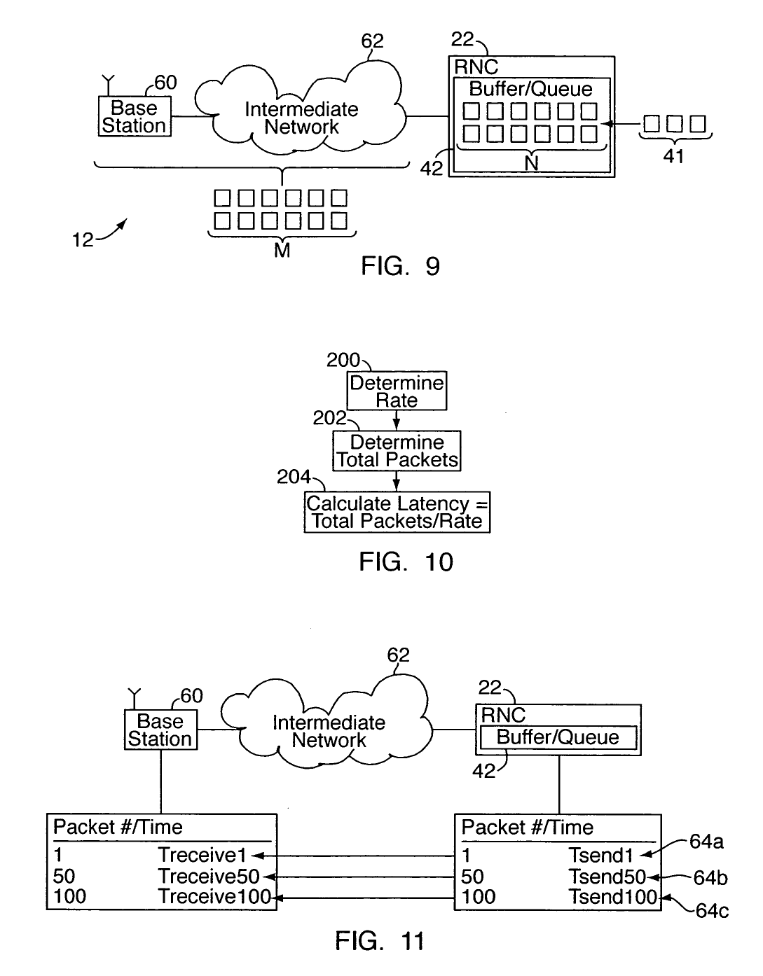

Transmission latency may also be calculated using means other than flow control messages 24a, 24b. FIGS. 9 and 10 show a more general method for calculating transmission latency. Here, the radio access network 12 is represented in simplified form, and includes the RNC 22, a base station 60, and an “intermediate network” 62 interconnecting the two. The intermediate network includes whatever queues and other network elements are interposed between the RNC 22 and base station 60 (such as the multiplexer 48 and router 46). In carrying out ongoing communication operations, packet data 41 (e.g., intended for a particular wireless unit 18a-18c) arrives at the RNC 22 and is stored in the pre-buffer or other queue 42. Subsequently, the packet data is routed out over the intermediate network 62 and to the base station 60 for transmission out over the forward link 28. At any given time, there may be “M” data packets in the intermediate network and base station, and “N” data packets in the RNC pre-buffer 42. To calculate latency, at Step 200 the transmission rate of packets (or other data) in the RAN 12 is determined. Then, at Step 202 the total number of packets “M+N” is determined; again, this represents the total number of packets remaining in the RAN 12 addressed to a particular wireless unit that have not yet been transmitted over the forward link. Then, at Step 204 the latency is calculated as:

$$\begin{matrix}Latency ( seconds ) = remaining data / rate \\ = M + N ( packets ) / rate ( packets / sec )\end{matrix}$$

The rate can be determined in a number of different ways, e.g., as described above with respect to flow control messages. Alternatively, the rate can be approximated at the base station 60 by measuring the how fast packets come into the base station and/or how fast packets leave the base station. For example, if a data packet number “X” is at the top of the base station queue (for transmission over the forward link) at time t=t1, and data packet number “Y” is at the top of the base station queue some later time t=t2, then the rate could be approximated as rate=#packets/time=(Y−X)/(t2−t1). (This assumes that packets are consecutively numbered and that Y>X.) Thus, if a first packet is at the top of the base station queue at time t1=0, and the fifty-first data packet is at the top of the base station queue some time later, at t2=100 ms, then the transmission rate could be approximated as TR=(51−1) packets/100 ms=0.5 packet/ms.

The rate may also be calculated through the use of messages sent from the base station to the RNC or vice versa. Such messages may also be used for determining the total number of packets for calculating latency. Generally, each message will contain (i) information identifying a data packet, and (ii) time information associated with that data packet, e.g., a time of reception, transmission, or the like. The time information in the message is then compared to a time reference point relating to that data packet or another data packet, e.g., an earlier or later time point of when that data packet or another data packet was at a particular location in the RAN 12. In effect, the transmission rate is a calculation of the amount of packets flowing past a specific point in unit time. More accurate results may be obtained by configuring the system to determine the amount of time required for a plurality of data packets to traverse the RAN 12.

For example, the RNC 22 may be configured to send messages to the base station 60 relating to the times when particular packets were sent out over the intermediate network 62. This is shown graphically in FIG. 11. Here, as is typically done in a 1×-EVDO network, the packets are numbered on an RNC/base station basis, meaning that each packet is specifically identifiable. Periodically, the RNC 22 generates messages 64a-64c, each identifying a packet and the time the packet was transmitted. Alternatively, the messages may relate to when the messages were received at the RNC. For example, a first message might indicate that a packet #1 was sent at time “Tsend1,” a second, subsequent message might indicate that a packet #50 was sent at time “Tsend50,” and a third message might indicate that a packet #100 was sent at time “Tsend100.” The messages may be sent each time a certain number of packets is transmitted, such as every 50 packets, as above (e.g., packet/time format), or after a designated time period has elapsed (e.g., time/packet format):

| | |
|---|---|
| PACKET/TIME FORMAT | TIME/PACKET FORMAT |

| PACKET | TIME | TIME | PACKET |
|---|---|---|---|
| 1 | Tsend1 | 0 | 1 |
| 50 | Tsend50 | +50 ms | “X” (>1) |
| 100 | Tsend100 | +100 ms | “Y” (>X) |

The base station 60 receives the messages 64a-64c, and also tracks the times when the message packets arrive at the base station. For example, as indicated in FIG. 6, the base station might note that packet #1 was received at time “Treceive1”, that packet #50 was received at time “Treceive50”, and that packet #100 was received at time “Treceive100.” (It is also possible for the base station to track when the packets were transmitted out over the forward link.) Any of these can be used as a time reference point for calculating the transmission rate TR:

TR=total packets/(Treceive100−Tsend1)

As should be appreciated, this encompasses the entire time between when the RNC transmitted the first designated packet (packet #1) and the base station received (or transmitted over the forward link) the last designated packet, packet #100. “Designated” packet refers to packets within an observation window, not necessarily the first or last packets addressed to a wireless unit. Also, although “Tsend1” is contained in the message received at the base station from the RNC while “Treceive100” is determined at the base station, the base station and RNC have synchronized clocks for carrying CDMA communications.

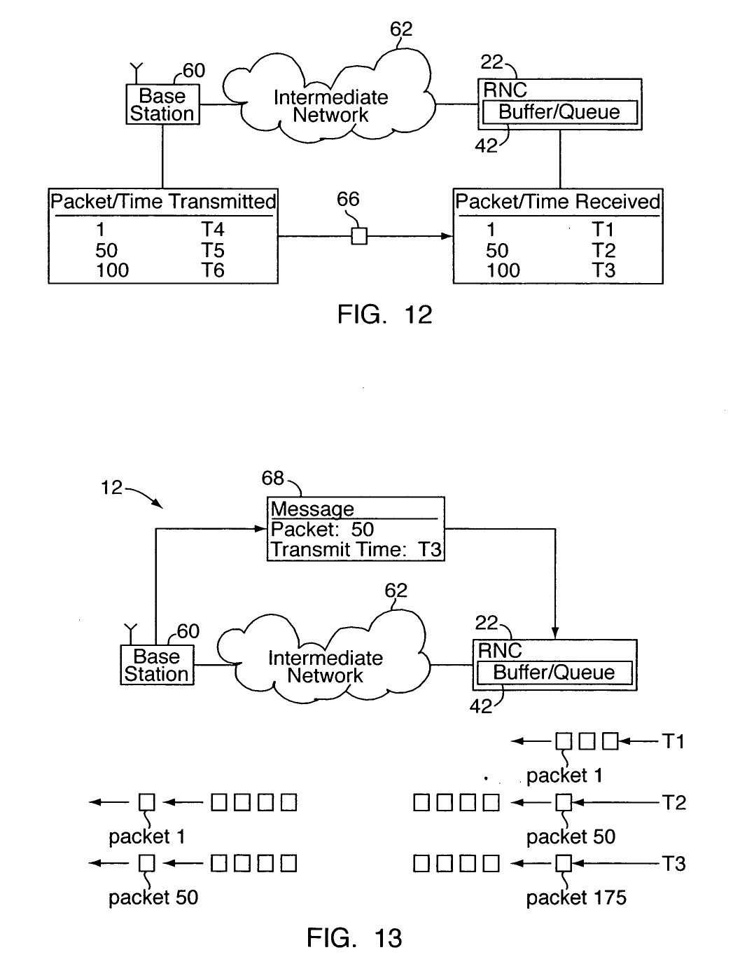

As shown in FIG. 12, instead of the RNC sending messages to the base station, the RNC may track when certain packets are received or transmitted by it. For example, in FIG. 12 packet #1 is received at the RNC at time T1, packet #50 at time T2, and packet #100 at time T3. The base station 60 periodically sends messages 66 back to the RNC indicating when the base station received or transmitted the packets. For example, a first message might indicate that the base station transmitted packet #1 at time T4, a second message might indicate that packet #50 was transmitted at time T5, and a third message that packet #100 was transmitted at time T6. The RNC would subsequently calculate the transmission rate as, for example, the total number of packets between first and last designated packets (#1 and #100) divided by the time difference between when the base station transmitted the last designated packet (“T6”), as indicated in a message 66 received by the RNC from the base station, and a time reference point of when the RNC received the first designated packet (“T1”).

Messages between the base station and RNC may also be used for determining the total number of data packets or other data queued in the radio access network 12 for transmission to a wireless unit, for latency calculations. The messages may be used simultaneously for both rate and latency calculations. This is shown graphically in FIG. 13. In an ongoing manner, data packets are received at the RNC, transmitted over the intermediate network, received at the base station, and transmitted by the base station over the forward link. Thus, at time T1, packet #1 is received at the RNC. At time T2, packet #50, for example, is received at the RNC, and packet #1, for example, is set for transmission over the forward link by the base station. At time T3, packet #175 is received at the RNC, and packet #50 is set for transmission over the forward link. At time T3 (or it could be at some other time), the base station 60 transmits a message 68 back to the RNC 22. The message identifies the current packet being transmitted over the forward link, e.g., the packet at the head of the base station transmission queue (here, packet #50), and the time of transmission (here, time T3). Using the information in this message, the RNC 22 is able to calculate the transmission rate as the amount of time required for a certain number of packets to make their way through the RAN 12. Here, packets #1-50 passed through the RAN 12 in the time period between T1 (a time reference point) and T3 (the time information in the message 68). Thus:

TR=50 packets/(T3−T1) seconds

The message 68 also identifies the “earliest” packet still left in the RAN 12, here, packet #50. Since the RNC 22 knows the identity of the packet that it most recently received prior to time T3, here, packet #175, the total number of packets remaining in the RAN 12 (e.g., addressed to a particular wireless unit) is 175−50=125. The latency can then be calculated as:

$$\begin{matrix}Latency = remaining packets / rate \\ = ( 125 / 50 ) \cdot ( T 3 - T 1 ) seconds\end{matrix}$$

The timing and content of the messages may vary. For example, messages may be sent based on time or on the number of received packets, as noted above. Messages do not have to be sent continually. Instead, it is possible for messages to be sent in a staggered periodic manner, e.g., messages are sent during a 1-minute period, then no messages for 4 minutes, then messages for 1 minute, and so on. Also, the measurement points may vary, e.g., time information can relate to when packets are received, transmitted, or otherwise.

Since certain changes may be made in the above-described method for carrier growth planning based on measured airlink transmission latency or other performance indicators in a 1×-EVDO wireless network, without departing from the spirit and scope of the invention herein involved, it is intended that all of the subject matter of the above description or shown in the accompanying drawings shall be interpreted merely as examples illustrating the inventive concept herein and shall not be construed as limiting the invention.

We claim:

1. A method for assessing airlink performance in a wireless network, said method comprising the steps of:
comparing at least one airlink performance indicator to at least one performance criterion for data transfer over the airlink, said at least one performance indicator relating to at least one of a user perceived throughput of the airlink and a transmission latency of the airlink; and
determining whether to increase airlink capacity based on said comparison.

2. The method of claim 1 further comprising:
measuring the at least one airlink performance indicator for a plurality of different wireless units at a plurality of different times; and
performing at least one statistical operation on the at least one performance indicator, prior to said step of comparing the at least one airlink performance indicator to the at least one performance criterion.

3. The method of claim 2 wherein the network is a 1×-EVDO network, and the at least one performance indicator relates to batch data transfer over the airlink.

4. The method of claim 3 wherein the at least one airlink performance indicator is measured as a function of airlink loading.

5. The method of claim 4 wherein the airlink loading is measured as a percentage of busy slots in the airlink.

6. The method of claim 1 further comprising:
increasing airlink capacity if the at least one performance indicator fails to meet the at least one performance criterion; and
if the at least one performance indicator meets the at least one performance criterion, re-measuring the at least one airlink performance indicator and repeating the step of comparing the at least one airlink performance indicator to the at least one performance criterion, at a later time from when the performance indicator and performance criterion were previously compared.

7. The method of claim 6 wherein:
the at least one airlink performance indicator is re-measured for a plurality of different wireless units at a plurality of different times; and
the method further comprises performing at least one statistical operation on the at least one performance indicator, prior to repeating said step of comparing the at least one airlink performance indicator to the at least one performance criterion.

8. The method of claim 7 wherein the network is a 1×-EVDO network, and the at least one performance indicator relates to batch data transfer over the airlink.

9. The method of claim 8 wherein the at least one airlink performance indicator is measured as a function of airlink loading.

10. The method of claim 9 wherein the airlink loading is measured as a percentage of busy slots in the airlink.

11. The method of claim 1 wherein:
the at least one performance criterion comprises (i) at least one performance criterion for a best efforts flow in the airlink, and (ii) at least one performance criterion for an expedited forwarding flow in the airlink;
the at least one performance indicator comprises (i) at least one performance indicator for the best efforts flow in the airlink, said at least one best efforts performance indicator being compared to the at least one best efforts performance criterion, and (ii) at least one performance indicator for the expedited forwarding flow in the airlink, said at least one expedited forwarding performance indicator being compared to the at least one expedited forwarding performance criterion; and
the determination of whether to increase the airlink capacity is based on said comparisons.

12. The method of claim 11 further comprising:
increasing airlink capacity if the at least one best efforts performance indicator fails to meet the at least one best efforts performance criterion, or if the at least one expedited forwarding performance indicator fails to meet the at least one expedited forwarding performance criterion; and
repeating the comparisons of best efforts and expedited forwarding performance indicators and criteria, at a later time from when the performance indicators and performance criteria were previously compared, if the at least one best efforts performance indicator meets the at least one best efforts performance criterion, and if the at least one expedited forwarding performance indicator meets the at least one expedited forwarding performance criterion.

13. The method of claim 12 further comprising:
measuring each of the at least one best efforts performance criterion and the at least one expedited forwarding performance criterion for a plurality of different wireless units at a plurality of different times, wherein the performance indicators are subjected to at least one statistical operation prior to comparison to the at least one performance criteria.

14. The method of claim 13 wherein the network is a 1×-EVDO network, and the performance indicators relate to batch data transfer over the airlink.

15. The method of claim 14 wherein the performance indicators are measured as a function of airlink loading.

16. The method of claim 15 wherein the airlink loading is measured as a percentage of busy slots in the airlink.

17. A method for assessing carrier growth in a wireless network, said method comprising the steps of:
determining if at least one performance indicator of a network airlink meets at least one performance criterion for data transfer over the airlink, wherein the at least one performance indicator relates to at least one of a user perceived throughput of the airlink and a transmission latency of the airlink; and
increasing airlink capacity if the at least one performance indicator fails to meet the at least one performance criterion.

18. The method of claim 17 further comprising, if the at least one performance indicator meets the at least one performance criterion:
re-measuring the at least one airlink performance indicator;
determining if the at least one re-measured performance indicator meets the at least one performance criterion; and
increasing airlink capacity if the at least one re-measured performance indicator fails to meet the at least one performance criterion.

19. The method of claim 18 wherein the network is a 1×-EVDO network, and the at least one airlink performance indicator is measured as a function of airlink loading.

20. A method of assessing airlink performance in a wireless network, said method comprising the steps of:
comparing at least one performance indicator of a best efforts flow over the airlink to at least one performance criterion for best efforts data transfer over the airlink;
comparing at least one performance indicator of an expedited forwarding flow over the airlink to at least one performance criterion for expedited forwarding data transfer over the airlink;
determining whether to increase airlink capacity based on said comparisons.
